(19) United States
(12) Patent Application Publication
(10) Pub. No.: US 2020/0074727 A1
(43) Pub. Date: Mar. 5, 2020

(54) Generating 3D Models

(71) Applicant: Moolean Inc., Henderson, NV (US)

(72) Inventor: Kishore Mulchandani, Henderson, NV (US)

(73) Assignee: Moolean Inc., Henderson, NV (US)

(21) Appl. No.: 16/119,893

(22) Filed: Aug. 31, 2018

(51) Int. Cl. G06T 17/00; G06T 7/543

(52) U.S. Cl. CPC G06T 17/00; G06T 7/543

(57) ABSTRACT

A computer-implemented system and method for identifying and analyzing closed loops within input graphical data to define 2D shapes having outlines; selecting a first function based on the outline and a second function to define points within the shapes; applying the first function to the defined points to obtain an output value for each point; and generating a three-dimensional (3D) model based on the output values.

### TECHNICAL FIELD

Embodiments generally relate to computerized three-dimensional (3D) modeling, and in particular to the generation of 3D models from two-dimensional (2D) outlines.

### BACKGROUND

Many industries use 3D models. They may be used, for example, to design physical products to be manufactured, as virtual graphics for software applications, architectural shapes for buildings, designs for 3D printing, etc. Many types of 3D modeling software exist, often having functionality that is suited to a particular industry or field.

Some 3D modeling software products include interfaces for use in extrusion or 3D printing. In 3D modeling, these generally refer to an operation that generates a physical or virtual rendering of a 3D model. For example, the software may allow a user to input data of a varying curved surface, the software will render a 3D model having such a surface, and through the interface will control a tool for creating a physical version of the 3D model, or a view screen for displaying a virtual version of the 3D model.

### SUMMARY

A computer-implemented system and method for identifying and analyzing closed loops within input graphical data to define 2D shapes having planar outlines; selecting a first function based on the outlines and a second function to define points within the shapes; applying the first function to the defined points to obtain an output value for each point; and generating a three-dimensional (3D) model based on the output values.

It is to be understood that both the foregoing general description and the following detailed description are exemplary and explanatory, and are not intended to be limiting unless otherwise specified. In particular, they are intended to provide further explanation of the invention as claimed.

### BRIEF DESCRIPTION OF THE DRAWINGS

The drawings illustrate disclosed embodiments and/or aspects of the invention and, together with the description, serve to explain the principles of the invention, the scope of which is determined by the claims. In the drawings, like reference numerals indicate identical or similar elements. Additionally, the left-most digit(s) of a reference number identify the drawing in which the reference number first appears.

FIG. 1A shows an illustrative 2D outline, with points within the outline, from which a 3D model may be defined as a function of the outline, in accordance with the disclosure.

FIG. 1B illustrates a portion of a 3D model created as a function of the outline illustrated in FIG. 1A.

FIG. 2A is a more complex 2D outline consisting of closed loop shapes, and points within the outline, from which a function may be used to define a 3D model, in accordance with the disclosure.

FIG. 2B illustrates a 3D model defined by a function of the outline of FIG. 2A different than the function used to define the model illustrated in FIG. 1B, in accordance with the disclosure.

FIG. 2C illustrates another 3D model based on the outline illustrated in FIG. 2A, and based on the model illustrated in FIG. 2B.

FIG. 3 is a flowchart of a method for creating 3D models as a function of a 2D closed loop outline, according to an example embodiment.

FIG. 4 is an example computing environment in which various aspects of disclosed embodiments may be realized.

### DETAILED DESCRIPTION

It is to be understood that the figures and descriptions provided herein may have been simplified to illustrate aspects that are relevant for a clear understanding of the herein described processes, machines, manufactures, and/or compositions of matter, while eliminating for the purpose of clarity other aspects that may be found in typical devices, systems, and methods. Those of ordinary skill in the pertinent art may recognize that other elements and/or steps may be desirable and/or necessary to implement the devices, systems, and methods described herein. Because such elements and steps are well known in the art, and because they do not facilitate a better understanding of the present disclosure, a discussion of such elements and steps may not be provided herein. However, the present disclosure is deemed to inherently include all such elements, variations, and modifications to the described aspects that would be known to those of ordinary skill in the pertinent art.

It will be readily understood that aspects of the present invention may be arranged in a variety of different configurations. Thus, the following detailed description and the attached figures are not intended to limit the scope of the invention as claimed, but are merely representative of selected embodiments of the invention. The aspects and characteristics described and illustrated may be combined in any suitable manner in one or more embodiments. For example, the phrases “example (or exemplary) embodiments”, “some embodiments”, and other similar language should be understood to mean the described aspects and characteristics may pertain to at least one embodiment of the invention. Thus, appearances of the phrases “example embodiments”, “in some embodiments”, “in other embodiments”, or other similar language throughout this specification do not necessarily refer to the same embodiments.

In the embodiments and aspects disclosed and illustrated herein, a 3D model is generated based on a function of closed loop lines making up a 2D line drawing lying on a plane. The exact shape of the 3D model is defined by the function of the 2D line. In embodiments, the shape is related to the function by using the value of the function at select points in the shape to define the height of the 3D model at that point, in a direction normal to the plane of the 2D line drawing. In other embodiments, the shape may be further defined by a second function that need not be based on the 2D line drawing, such as a step function for example. Other functions, and combinations of functions, may additionally or alternatively be used to define the shape of the 3D model.

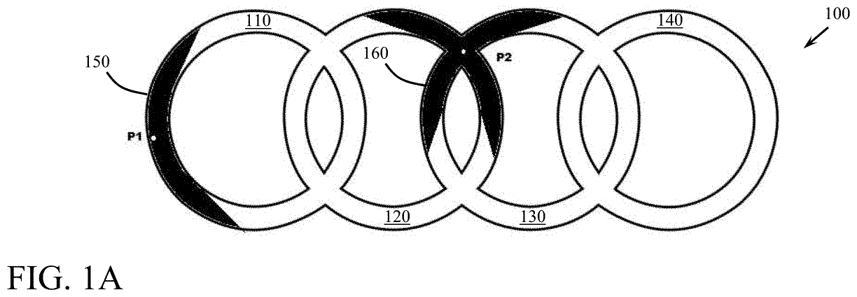

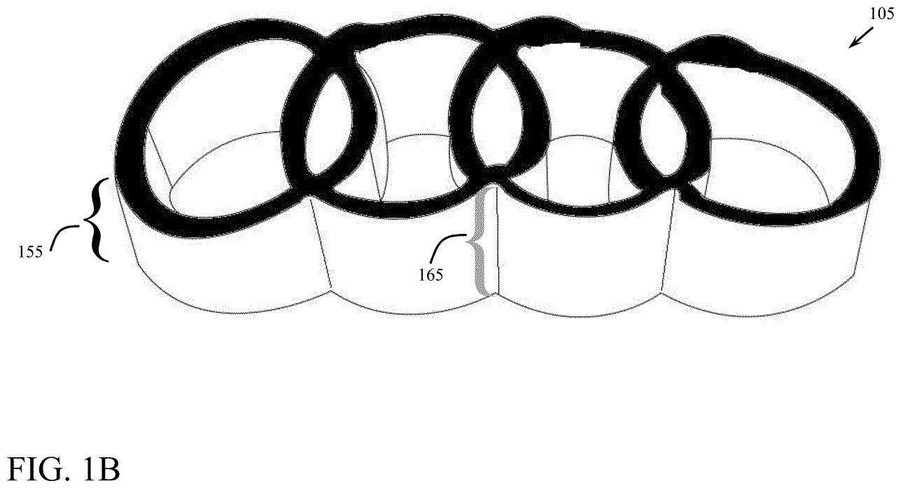

Referring now to the figures, FIG. 1A illustrates a line drawing 100 comprising only closed loops (neglecting for a moment the black shaded areas). That is, there is no line in the illustration that has an end. Conventionally, starting from outside the outermost boundary of the line drawing, and moving in a straight path across any number of the lines making up the line drawing, the first of those lines encountered defines the limit of a 2D shape that begins the “inside” of a first portion of the shape; the second line defines another limit of the shape that begins the “outside” of that portion of the shape, as a “blank” area that is not part of the shape. The next line encountered defines the inside of another portion of the same or a different shape, and the line after that defines the outside of that portion, which is blank, and so on. Finally, the last line of the shape is encountered along the straight path chosen, and it defines the outside of a portion of the shape furthest from the first line encountered along that straight path. So for example, the line drawing shown in FIG. 1A can be understood to be a shape comprising four overlapping rings, 110, 120, 130, and 140.

FIG. 1A also shows two points P1 and P2 within the “inside” portion of the shape, i.e., sitting “on” the rings. P1 sits on the ring 110 on the left of the illustrated shape, while P2 sits on an intersection of the two central rings 120, 130. The portions of the rings that can be “seen” from P1 and P2 are shaded black. In other words, if a ray having an origin at a point within the boundaries of the shape sweeps through 360°, the black shaded areas represent the areas within the shape the ray would sweep through, without crossing any of the shape's borders. Thus, the black shaded area 150 in which P1 sits is the area that would be swept through by a ray having an origin at P1, and so can be “seen” from P1. Likewise, the black shaded area 160 in which P2 sits is the area that would be swept through by a ray having an origin at P2, and so can be “seen” from P2. A “visibility” function is defined as a measure of the black shaded area encountered by a sweeping ray at any point on the shape. A 3D model can be formed by extending the 2D shape in a direction perpendicular to the plane in which the 2D shape sits. In particular, the model can be formed by extending every point within the 2D shape to a height defined by the visibility function at that point. FIG. 1B shows an approximation of a portion of such a model 105. As shown, the height of the model is highest 165 where the rings intersect, for example at P2, and lower where the rings do not intersect 155, for example at P1. Thus in this embodiment, the model is the result of defining a height at every point within the 2D shape as a function of the closed loop lines making up the 2D line drawing that defines the shape.

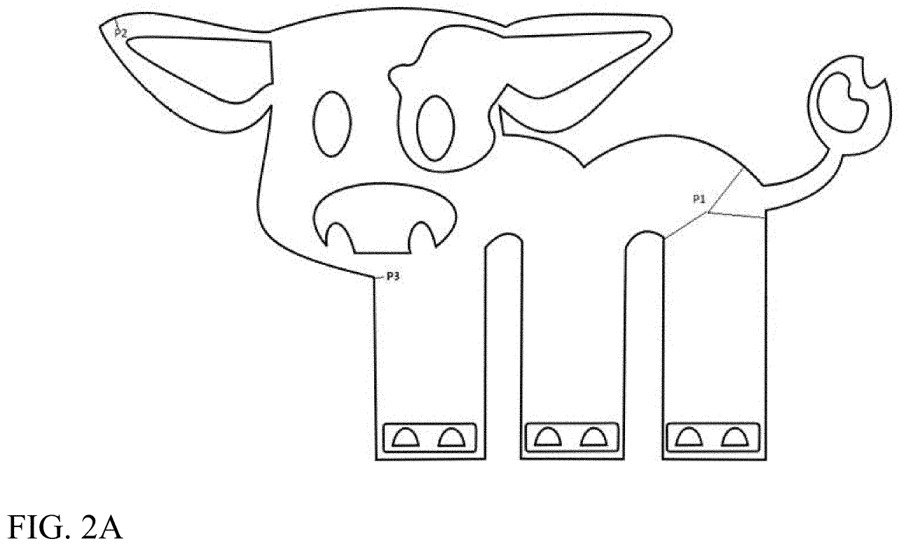

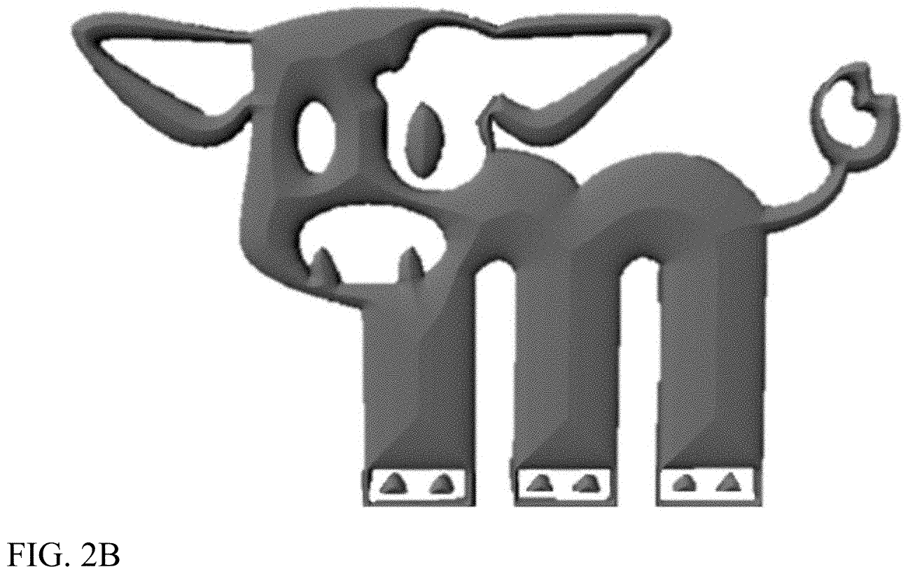

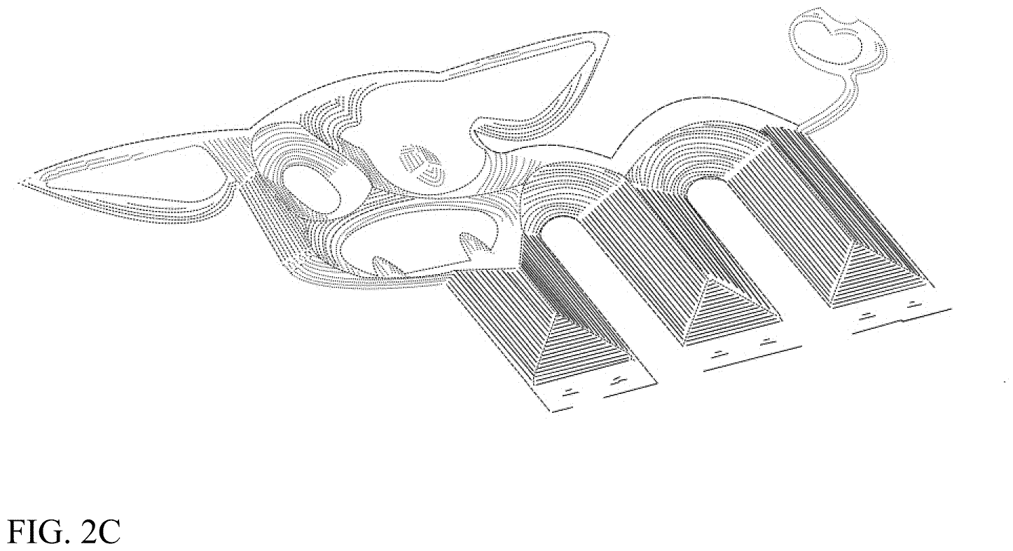

FIG. 2A is another line drawing comprising only closed loops. In this case, the line drawing is of a stylized cow, comprising various areas defined by the closed loops making it up. Using the convention described previously, some of the areas are “blank”, and some of the areas that are not blank are isolated by blank areas from the other non-blank areas. For example, the legs are not blank, and the feet are blank, and the hooves are not blank and are separated from the legs by the blank feet.

FIG. 2A shows three points P1, P2, and P3, within the “inside” portion of the shape. P1 sits on the rear end of the cow toward the right of the illustrated shape; P2 sits on the cow's ear at the far left of the illustrated shape; and P3 sits just under the cow's face. Line segments are shown extending from each of the points to the nearest border of the shape. The line segments at P2 and P3 are short, and there is only one line segment extending from them because the points P2 and P3 are very near to the nearest border. The point P1, however, is equidistant to three different borders, shown by three line segments.

FIG. 2B is 3D model with a height that is variable, in accordance with a function that is based on the 2D line drawing, but a different function than that used to generate FIG. 1B. In this case, the height of the 3D model is defined by the distance from any point within the shape formed by the 2D line drawing to the nearest boundary. Points close to a boundary will have a lower height, and points proportionally farther from any boundary will be correspondingly higher. This function is called a distance function (DF), and FIG. 2B shows the resulting model. It is noted that an inverse function can be used to define an engraving or carving out of a solid substrate, where the depth of the carving is defined by the distance function, instead of the height of an extrusion or the like.

Another, similar function (not shown) can be used that accounts for the height of a model at points within the 2D shape, and the same characteristic (distance from the nearest border) for the blank areas enclosed within the 2D shape. In this case, the distances from points within the shape to the nearest border define the height of the model, and the distances from points the blank areas define a negative height (i.e., a depth) that would be realized as an engraving, or a carving out of a solid substrate from a flat surface of the substrate defined as having a height of zero. This function is called a signed distance function (SDF).

FIG. 2C is a perspective view of a 3D model based on the model of FIG. 2B, combined with a step function applied to that model. In particular, a third function is applied to the surface of the 3D model of FIG. 2B to obtain an output. The third function output is used to generate the modified 3D model illustrated in FIG. 2C. In the case of FIG. 2C, the third function is a step function that, when applied to the surface of the 3D model of FIG. 2B, gives the 3D model illustrated in FIG. 2C.

In general, the resulting 3D models can be rendered in a physical form using 3D printing, molding, milling, or other means of manufacturing tangible 3D objects. In addition, intangible virtual 3D models may be formed in the same way, but rendered as 3D visualizations, animations, and other computer generated graphics realized entirely in the digital realm. Uses of such tangible and intangible 3D models can include logos, signage, posts, and the like, that may be built up or embossed, or carved out or engraved, or both. The method can also be used to model architectural shapes such as buildings having a height determined by the functions and combinations of functions disclosed herein.

Aspects of the invention can be realized using one or more method steps or algorithms that can be implemented using a software program executing on a computing processor of a computing environment. Such software can be based on source code written in any programming language, and executed on any computing environment for which the code has been compiled or can be interpreted. Typically, the computer instructions may be stored on a tangible computer-readable storage device operatively coupled to the computing processor, which reads the storage device and executes the instructions. Such a processor can then perform, or cause other operatively coupled devices to perform, the operations disclosed herein.

In exemplary operations, a 3D model's structure can be based on 2D shapes that can be input as one or more lines or curves forming one or more closed loops. The shapes may be defined algorithmically and saved in a vector-based image file that can be used as input. In addition or alternatively, shapes may be sketched using a writing utensil on paper or other appropriate material, and scanned using a physical scanner to create a raster-based digital graphic file, which can be used as input. Other types of graphical data, such as the output of a computerized drawing tablet or touch screen responsive to movement of a stylus or the like on its working surface, can also be used. These 2D inputs can then be processed to recognize the closed loops as 2D shapes, and produce a collection of points classified as being either inside or outside the 2D shapes.

In embodiments, functions and other inputs can be further manipulated using one or more nested functions in 1, 2 or 3 dimensions. For example, a linear, trigonometric, or other function can be applied to the output of a signed distance function (from which a 3D model can be generated), which is itself based on the 2D outlines shapes based on original graphical input. The nested function(s) can be used to generate a completely new 3D model that has a completely different look. In mathematical terms, the genesis of a “first level” 3D model is a function of the boundaries of 2D shapes, and points in those shapes, and optionally including any blank spaces completely enclosed by those shapes as enclosed shapes. In an aspect of the disclosed embodiments, the first function operates on the outlines of the 2D shape. Additionally or alternatively, the first function operates on points within the shape, which points are defined by a second function. Thereby, a variety of 3D shapes and surfaces may be generated by following a predefined procedure or protocol. The various 3D models generated therefrom have an appearance that is distinctly different from 3D models generated using prior art approaches. The 3D models based on a function of a 2D closed loop image may provide smooth or abrupt transitions with respect to a blank background, depending on the function(s) used. In embodiments, the functions that define the 3D shape can be further convoluted (or otherwise combined) with other functions to produce various 3D effects.

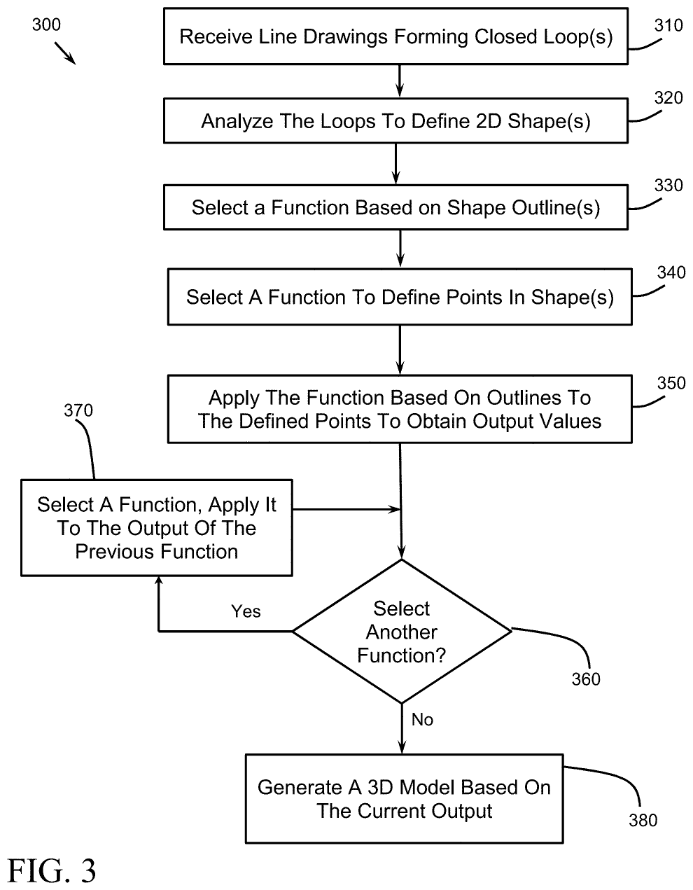

FIG. 3. is a flow chart of an exemplary method 300 for generated 3D models. The method begins by inputting 310 into a 2D image analyzer one or more 2D curves that form one or more closed loops. The closed loops are recognized and analyzed 320 to define one or more shapes, each shape enclosing multiple points within outlines formed by the closed loops. The outlines of each shape can thus be understood to comprise multiple points. There may be other points not within the shapes, but which are enclosed by the shapes. If so, those points may also be used to define a portion of a 3D model, in some way distinct from the portion defined by the points within the shapes.

A function is selected 330 that is defined in some way by the outlines. Exemplary functions of this kind are the visibility function discussed in connection with FIG. 1, the distance function (DF) discussed in connection with FIG. 2, and the signed distance function (SDF) discussed at the same time. Another function is selected to define points enclosed within the shapes, 340. Because there are an infinite number of points within any enclosed area, the points to be operated upon by the selected outline-based function may be determined in any desired manner that can be algorithmically described. For example, a regular array of points may be used, each one equidistant from its nearest neighboring points and thus having a uniform density. The distance between points in the array may be set in any desired manner, which changes their density. Alternatively or additionally, points may be selected based on their proximity to an outline, with a density based on the curvature of the outline at those points. These and other procedures for selecting functions and points may be used, and are within the scope of the disclosure. The selected outline-based function is then applied 350 to points within the outlines making up the shape.

A determination is made whether another function is to be applied, 360. If so, the function to be applied is selected, and applied to the output of the previous function, 370. The method loops back to check if another function is to be applied 360. If so, the function to be applied is selected, and applied to the output of the previous function, 370. When no more functions are to be applied, the method proceeds to generate a 3D model using the output of the most recently applied function, 380. The 3D model can be generated by treating the output of the most recently applied function in any desired manner that can be algorithmically described, to determine points on the surface of the 3D model that correspond in some way to the points within the 2D shape that were originally selected. For example, in an embodiment the value of the output of the last applied function can be used to define the height of the 3D model in a direction normal to the plane of the original shape.

Alternatively, after a determination is made to apply another function 360, a 3D surface can be generated from the most recent output, and a function may be chosen to define points on that surface. Then another function may be selected and applied, based not on the output of the previous function, but based on the points defined on the surface generated from the output of that function, as an alternative to step 370. The method then loops back to check if another function is to be applied 360. If so, the original step 370, or the alternative to step 370, can be used in each additional iteration until no more functions are selected, and the 3D model is generated 380. The 3D model can be generated by treating the output of the most recently applied function in any desired manner that can be algorithmically described, to define the surface of the 3D model.

Areas enclosed within the original shapes can be regarded as enclosed shapes, and may be treated similarly to the treatment of the original, enclosing shapes, in accordance with the method of FIG. 3, using the same or different functions, number of functions, and point selection algorithms. For example, if a distance function (DF) is used to extend each selected point within the enclosing shapes in a first direction, a DF can also be used to extend in the same direction, or in the opposite direction, for each defined point within the enclosed shapes. If the DF of the enclosed shapes yields negative values as opposed to positive values of the enclosing shapes, this will produce a 3D model that is both embossed and engraved with reference to a plane defined everywhere to have a value of zero. Alternatively as noted, the enclosed shapes may be extended in the same direction as the original shapes. Or, the enclosed shapes may be treated using a function or set of nested functions separate and distinct from the function or set of nested functions used in the treatment of the points within the enclosing shapes.

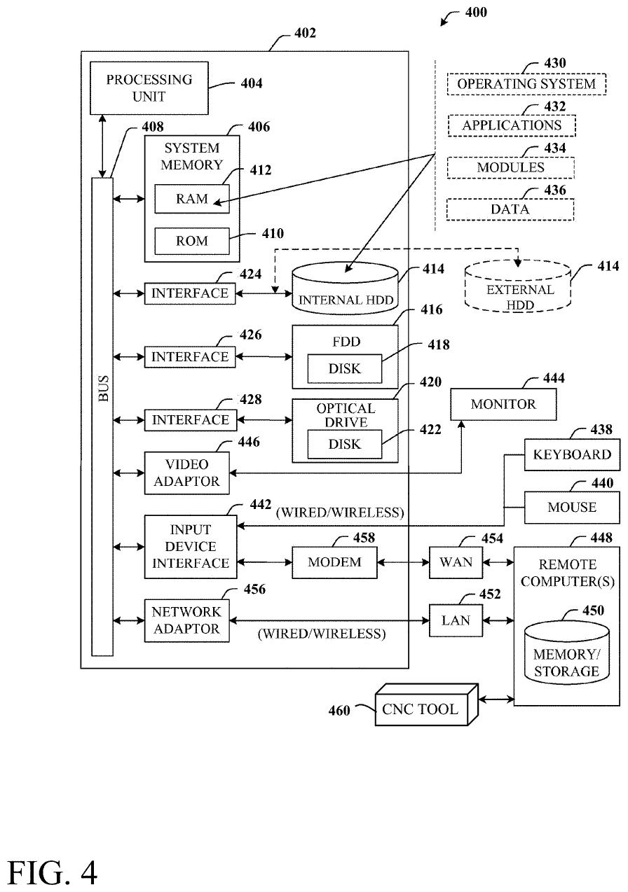

FIG. 4 is a block diagram of an illustrative computing environment 400 with which various aspects of the disclosed embodiments may be implements. The computing environment 400 includes a computer 402 having a processing unit 404, a system memory 406 and a system bus 408. Processing unit 404 may comprise, by way of example, one or more central processing units (CPUs), graphics processing units (GPUs) or any combination thereof. The system bus 408 couples system components including the system memory 406 to the processing unit 404. The system bus 408 may further connect to a memory bus (with or without a memory controller), a peripheral bus such as a universal serial bus (USB), or other local bus using any of a variety of commercially available bus architectures. The system memory 406 may include read only memory (ROM) 410 and random access memory (RAM) 412. A basic input/output system (BIOS) may be stored in a non-volatile memory 410, such as a ROM, EPROM, EEPROM, or the like. The BIOS contains the basic routines that help to transfer information between elements within the computer 402, such as during start-up. The RAM 412 can be or include a high-speed memory such as static RAM for caching data.

The computer 402 includes one or more data storage devices, such as hard disk drives (HDD) 414, which may be disposed inside and/or outside of a suitable chassis. As shown, computer 402 also includes a drive 416 for use with a removable magnetic storage medium 418 on which data can be written and read from, and an optical drive 420 for use with a removable optical disk 422 such as a CD or DVD. The hard disk drive 414, magnetic disk drive 416 and optical disk drive 420 can be connected to the system bus 408 via a hard disk drive interface 424, a magnetic disk drive interface 426 and an optical drive interface 428, respectively.

The drives and their associated computer-readable media provide nonvolatile storage of electronic data, data structures, computer-executable instructions, and the like. For example, the media may store computer-executable instructions that, when executed on the processor 404, cause the computer to perform the automated methods of the disclosed subject matter.

Program modules and the like can be fetched from a nonvolatile storage device and held in RAM 412 for speedy execution and access, including an operating system 430, one or more application programs 432, other program modules 434, and program data 436.

Commands and information can be entered into the computer 402 through one or more wired or wireless input devices, such as a keyboard/mouse 438 and a pointing device 440. These and other input devices may be connected to the processing unit 404 through input device interface 442 coupled to the system bus 408, which may be a USB port for example. A monitor 444 or other display device is also connected to the system bus 408 via an internal or external video interface, such as a video adapter 446. The monitor may be used to display any of the input curves, the closed loops formed by the input curves, the 2D shapes formed by the closed loops, the points selected within the shapes, or enclosed by the shapes, and a virtual 3D model formed by applying to the points a first function based on the outline of the 2D shapes. The monitor may also display a virtual 3D model based on applying an additional function or set of nested functions to the output of the first function.

Similarly, a computer controlled manufacturing environment can be operatively coupled to the computing environment 400 using any appropriate wired or wireless pathway known to those of skill in the art. For example, one or more computer numerical controlled (CNC) tools 460 can be used to manipulate a work piece to build a physical 3D model corresponding to any of the virtual 3D models viewable on a monitor as previously described. Examples of such tools include 3D printers, mills, lathes, cutters, engravers, embossers, and many more.

The computer 402 may operate in a networked environment using physical or logical connections via wired and/or wireless communications to one or more CNC tools, and/or to one or more remote computers, such as remote computer(s) 448. The remote computer(s) 448 can include one or more of a workstation, a server computer, a router, a personal or portable computer, any of which may include some or all of the elements described in connection with the computer 402. For example, a network attached storage device 450 is illustrated, and can be accessed by computers and other network attached devices. The logical connections depicted include wired/wireless connectivity to a local area network (LAN) 452 and can also include larger networks, such as the Internet.

For example, when used in a LAN networking environment, the computer 402 is connected to the local network 452 through a wired or wireless communication network interface or adapter 456. The adaptor 456 may facilitate wired or wireless communication to the LAN 452, which may also include a wireless access point disposed thereon for communicating with the wireless adaptor 456. In a networked environment, program modules depicted with regard to the computer 402, or portions thereof can be stored in the remote memory/storage device 450. It will be appreciated that the network connections shown are illustrative and other means of communication between computers can be used.

The computer 402 may be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, telephone). This can include Wi-Fi and Bluetooth wireless technologies, for example. Thus, the communication means can be a predefined structure as with a conventional network or simply an ad hoc communication between at least two devices.

WiFi is a technology for wireless local area networking with devices based on the IEEE 802.11 standards. It can be used, for example, to enable a user communications device to wirelessly connect to a network access point from a short distance away (e.g., 50 feet, more or less). Wi-Fi networks use radio technologies called IEEE 802.11x (a, b, g, etc.) to provide reliable, fast, securable wireless connectivity. A Wi-Fi network can be used to connect computers to each other, to the Internet, and to other wired and/or wireless networks and devices (which use IEEE 802.3 or Ethernet).

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein.

Although the invention has been described and illustrated in exemplary forms with a certain degree of particularity, it is noted that the description and illustrations have been made by way of example only. Numerous changes in the details of construction, combination, and arrangement of parts and steps may be made without deviating from the scope of the invention. Accordingly, such changes are understood to be inherent in the disclosure. The invention is not limited except by the appended claims and the elements explicitly recited therein. The scope of the claims should be construed as broadly as the prior art will permit. It should also be noted that all elements of all of the claims may be combined with each other in any possible combination, even if the combinations have not been expressly claimed.

What is claimed is:

1. A computer-implemented method controlled by a processor executing instructions obtained from a tangible storage device, the method comprising:
receiving input data defining at least one line as at least one two-dimensional (2D) closed loop;
analyzing the 2D closed loops to define at least one 2D shape having an outline lying in a plane;
selecting a first function to define points within the shapes;
selecting a second function based on the outline;
applying the first function to the defined points to obtain an output value for each point; and
generating a three-dimensional (3D) model based on the output values.

2. The method of claim 1, further comprising:
applying a third function to one of:
the output values of the second function, and
a surface of the 3D model based on the output values of the second function, to obtain a third function output; and
generating a modified 3D model based on the third function output.

3. The method of claim 1, wherein a height value for each respective point on the 2D plane in a direction normal to the plane is determined based on the output value of the first function applied at that point; and
wherein the 3D model is generated based on the height values.

4. The method of claim 1, wherein the function to define points within the shape(s) forms a regular pattern of points having a select distance between points.

5. The method of claim 1, wherein the function to define points within the shapes is based on the shapes' 2D outlines.

6. The method of claim 1, wherein the function based on the outline that will be applied to the defined points comprises at least one of a visibility function and a distance function (DF).

7. The method of claim 1, further comprising:
analyzing the 2D shapes to identify at least one 2D shape enclosed by another 2D shape and having as its outline a common border with the enclosing shape;
selecting a third function to define points within the enclosed shapes;
selecting a fourth function;
applying the fourth function to the defined points within the enclosed shapes to obtain an output value for each of those points; and
generating a 3D model based on the output values of the points in the enclosed shape.

8. The method of claim 7, wherein the fourth function is based on the outlines of the enclosed shapes.

9. The method of claim 8, wherein the second function applied to the points in the enclosing shapes, and the fourth function applied to the points in the enclosed shapes, together form a signed distance function (SDF) in which the output values of the points in the enclosed shape are defined as negative values and the output values of the points in the enclosing shape are defined as positive values; and
wherein a surface of the 3D model based on the negative output values in the enclosed shapes is lower than the 2D plane in which the common border lies, and the surface of the 3D model based on the positive output values in the enclosing shapes is higher than the 2D plane in which the common border lies.

10. The method of claim 1, further comprising:
generating 3D data based on the output values that when processed by a computer numerical controlled (CNC) device will create a physical 3D rendition of the 3D model, and when processed for display on a monitor will create a virtual 3D rendition of the 3D model; and
transmitting the data to at least one of a CNC device and a monitor.

11. A tangible computer-readable device having instructions stored thereon that, when executed by a processor, cause the processor to control devices operatively coupled thereto to perform a method comprising:
receiving input data defining at least one line as at least one two-dimensional (2D) closed loop;
analyzing the 2D closed loops to define at least one 2D shape having an outline lying in a plane;
selecting a first function based on the outline;
selecting a second function to define points within the shapes;
applying the first function to the defined points to obtain an output value for each point; and
generating a three-dimensional (3D) model based on the output values.

12. A system for generating 3D models, comprising:
a tangible computer-readable data storage device having computer instructions stored thereon;
an input device for inputting graphical data;
an output device for outputting a 3D rendering based on the graphical data; and
a processor operatively coupled to the storage device, the input device, and the output device, the processor configured to obtain instructions from the storage device and execute the instructions to control an automated performance of a method comprising:
receiving input data from the input device defining at least one line;
analyzing the input data to identify at least one two-dimensional (2D) closed loop;
analyzing the 2D closed loops to define at least one 2D shape having an outline lying in a plane;
selecting a first function to define points within the shapes;
selecting a second function based on the outline;
applying the second function to the defined points to obtain an output value for each point; and
generating a three-dimensional (3D) model based on the output values.

13. The system of claim 12, wherein the method controlled by the processor further comprises:
applying a third function to one of:
the output values of the second function, and
a surface of the 3D model based on the output values of the second function, to obtain an output; and
generating a modified 3D model based on the output of the third function.

14. The system of claim 12, wherein a height value for each respective point on the 2D plane in a direction normal to the plane is determined based on the output value of the second function applied at that point; and
wherein the 3D model is generated based on the height values.

15. The system of claim 12, wherein the first function, to define points within the shapes, is based on one of a regular pattern of points having a select distance between points, and a function based on the shapes' 2D outlines.

16. The system of claim 12, wherein the second function, based on the shapes' outlines, comprises one of a visibility function and a distance function (DF).

17. The system of claim 12, wherein the method controlled by the processor further comprises:
analyzing the 2D shapes to identify at least one 2D shape enclosed by another 2D shape and having as its outline a common border with the enclosing shape;
selecting a third function to define points within the enclosed shapes;
selecting a fourth function based on the common border;
applying the fourth function to the defined points within the enclosed shapes to obtain an output value for each of those points; and
generating a 3D model based on the output values of the points in the enclosed shape.

18. The system of claim 17, wherein the fourth function is based on the outlines of the enclosed shapes.

19. The system of claim 18, wherein the second function, applied to the points in the enclosing shapes, and the fourth function, applied to the points in the enclosed shapes, together form a signed distance function (SDF) in which the output values of the second function pertaining to the points in the enclosed shape are defined as negative values, and the output values of the fourth function pertaining to the points in the enclosing shape are defined as positive values; and
wherein the surface of the 3D model based on the negative output values in the enclosed shapes is lower than the 2D plane in which the common border lies, and the surface of the 3D model based on the positive output values in the enclosing shapes is higher than the 2D plane in which the common border lies.

20. The system of claim 12, wherein the method further comprises:
generating 3D data based on the output values that, when processed by a computer numerical controlled (CNC) device, will create a physical 3D rendition of the 3D model, and when processed for display on a monitor will create a virtual 3D rendition of the 3D model; and
transmitting the data to at least one of a CNC device and a monitor.
